(19) United States
(12) Patent Application Publication
(10) Pub. No.: US 2015/0372899 A1
(43) Pub. Date: Dec. 24, 2015

(54) COMMUNICATION SYSTEM AND NETWORK CONTROL DEVICE

(71) Applicant: Hitachi, Ltd., Tokyo (JP)

(72) Inventors: Takeshi SHIBATA, Tokyo (JP); Hiroyuki KUBO, Tokyo (JP); Toshiaki SUZUKI, Tokyo (JP); Masahiro KIMURA, Tokyo (JP); Kiyotaka TAKAHASHI, Tokyo (JP)

(21) Appl. No.: 14/725,175

(22) Filed: May 29, 2015

(30) Foreign Application Priority Data
Jun. 18, 2014 (JP) 2014-125171

(51) Int. Cl. H04L 12/707; H04L 12/24; H04L 12/801; H04L 12/741; H04L 12/26

(52) U.S. Cl. CPC H04L 45/24; H04L 45/745; H04L 43/087; H04L 47/12; H04L 41/0803

(57) ABSTRACT

A communication system is capable of re-examining an allocated communication path and a reserved communication path and implementing a rapid service provision in which a resource utilization efficiency is high without an interruption of service or an abrupt deterioration of quality when a reserved communication path is created in advance, and a reserved communication path is allocated according to an allocation request of a user. A communication path with quality assurance of data communication is implemented in a communication network with a communication path calculation device having a communication path managing unit and communication path calculating unit. The communication path managing unit manages reserved communication paths with quality assurance constructed based on a quality assurance communication path construction request of a communication system administrator and a use communication path allocated from among the reserved communication paths according to the quality assurance communication path allocation request of the communication network user.

### CLAIM OF PRIORITY

The present application claims priority from Japanese application serial no. JP2014-125171, filed on Jun. 18, 2014, the content of which is hereby incorporated by reference into this application.

### FIELD OF THE INVENTION

The present invention relates to a transfer device that transfers data, a communication path providing method, and a route change method.

### DESCRIPTION OF THE RELATED ART

In a communication network scheme, a communication scheme in which communication resources used for communication are occupied in association with a specific user and a communication scheme in which communication resources used for communication are occupied without association with a specific user are used. In the communication scheme in which communication resources are occupied in association with a specific the user, it is necessary to secure communication resources required by the specific user within a communication network and allocate the communication resources to the specific user, and thus it takes a time to open a communication service.

As a method of rapidly providing a communication service to the user of a communication scheme in which communication resources are occupied, there is a method of creating a communication path occupying communication resources in a network in advance and allocating a reserved communication path created in advance when a communication path allocation request is received from the user.

If the reserved communication paths are allocated according to the allocation request from the user, the reserved communication path created in advance is expended, and it may be difficult to cope with a new allocation request. In this case, a method of re-examining a reserved communication path appropriately depending on circumstances is considered (for example, see JP 2004-112693 A).

### SUMMARY OF THE INVENTION

### Problem to be Solved by the Invention

In a case in which a reserved communication path is created in advance in a communication network, and the reserved communication path is allocated according to an allocation request from the user, the reserved communication path is not necessarily created to satisfy the request from the user. In this regard, when the reserved communication path is allocated to the user, a reserved communication path having slightly excessive communication resources to satisfy the request from the user is allocated to the user. Thus, communication resources more than originally required by the user may be expended.

Further, when only the reserved communication path is re-examined, it is difficult to effectively use excessive communication resources allocated to the communication path being used by the user. Thus, it may be difficult to secure a reserved communication path that can be secured under normal circumstances.

### Means for Solving Problem

In order to solve the above problems, in one aspect of the present invention, an in-use communication path as well as a reserved communication path is re-examined.

As a specific configuration example of the present invention, a communication system in which a communication path with quality assurance of data communication is implemented in a communication network including a communication device and a communication path calculation device as a component can be configured. The communication path calculation device includes an input unit, an output unit, a storage unit, a communication path managing unit, and a communication path calculating unit.

The communication path managing unit manages reserved communication paths with quality assurance constructed based on a quality assurance communication path construction request of a communication system administrator input to the input unit and a use communication path allocated from among the reserved communication paths according to the quality assurance communication path allocation request of the communication network user input to the input unit.

The communication path calculating unit gives a priority to the reserved communication path and the use communication path, and reconfigures the reserved communication path and the use communication path in a priority order.

As another specific configuration example, a network control device including an input unit, an output unit, a storage unit, and a processing unit is configured.

This device is connected with a communication device configuring a network via the input unit and the output unit, and controls a setting of a communication path used by a user by controlling a setting of the communication device. Here, the input unit is a concept including all components used to input a signal or information to a device such as a keyboard or an input interface. Further, the output unit is a concept including all components used to output a signal or information from a device such as an image monitor, a printer, or an output interface.

The storage unit stores a requested path management table that stores information of a requested path serving as a communication path requested by the user, an in-use path management table that stores information of an in-use path serving as a communication path being used by the user, and a reserved path management table that stores information of a reserved path serving as a communication path that is secured in advance for use by the user. Quality information of a path or configuration information of a path may be stored in the tables. Further, a network configuration management table that stores information related to a configuration of the network is provided.

The processing unit includes a path selecting unit that selects a path for use by the user from the reserved path management table based on the information of the requested path.

The processing unit further includes a path calculating unit that aggregates information of the in-use path management table and information of the reserved path management table at a periodic or arbitrary timing, gives a priority to the in-use path and the reserved path, and re-calculates information of the in-use path and information of the reserved path in an order of the priority based on information of the network configuration management table. The re-calculation is a work of reconfiguring a path satisfying conditions requested by an in-use path and a reserved path using network resources stored in the network configuration management table.

The processing unit further includes a path managing unit that reflects a result of the re-calculating in the in-use path management table and the reserved path management table.

In the above description, the processing unit may be configured with software or may be configured with dedicated hardware.

### Effect of the Invention

In the present invention, since the in-use communication path as well as the reserved communication path is re-examined, it is possible to use network resources effectively.

A problem, a configuration, and an effect that are not described above will become apparent from the following description of embodiments.

### BRIEF DESCRIPTION OF THE DRAWINGS

FIG. 1 is a block diagram illustrating a communication system according to an embodiment of the present invention;

FIG. 2 is a flowchart illustrating a communication path re-examination process according to an embodiment of the present invention;

FIG. 3 is a sequence diagram illustrating a communication path creation/re-examination process according to an embodiment of the present invention;

FIG. 4 is a network diagram according to an embodiment of the present invention;

FIG. 5 illustrates a necessary reserved path management table according to an embodiment of the present invention;

FIG. 6 illustrates a path calculation management table according to an embodiment of the present invention;

FIG. 7 illustrates a reserved path management table according to an embodiment of the present invention;

FIG. 8 is a network diagram after a necessary reserved path is secured according to an embodiment of the present invention;

FIG. 9 illustrates a requested path management table according to an embodiment of the present invention;

FIG. 10 illustrates an in-use path management table according to an embodiment of the present invention;

FIG. 11 illustrates a reserved path management table after a requested path is allocated according to an embodiment of the present invention;

FIG. 12 illustrates a path calculation management table when a re-examination is performed according to a first embodiment of the present invention;

FIG. 13 illustrates an in-use path management table when a re-examination is performed according to the first embodiment of the present invention;

FIG. 14 illustrates a reserved path management table when a re-examination is performed according to the first embodiment of the present invention;

FIG. 15 is a network diagram after a re-examination is performed according to the first embodiment of the present invention;

FIG. 16 illustrates a path calculation management table when a re-examination is performed according to a second embodiment of the present invention;

FIG. 17 illustrates an in-use path management table when a re-examination is performed according to the second embodiment of the present invention;

FIG. 18 illustrates a reserved path management table when a re-examination is performed according to the second embodiment of the present invention;

FIG. 19 is a network diagram after a re-examination is performed according to the second embodiment of the present invention;

FIG. 20 illustrates a path calculation management table when a re-examination is performed according to a third embodiment of the present invention;

FIG. 21 illustrates an in-use path management table when a re-examination is performed according to the third embodiment of the present invention;

FIG. 22 illustrates a reserved path management table when a re-examination is performed according to the third embodiment of the present invention; and

FIG. 23 is a network diagram after a re-examination is performed according to the third embodiment of the present invention.

### MODE(S) FOR CARRYING OUT THE INVENTION

First, an overview of the present embodiment will be described. In the present embodiment, a communication system in which a communication path with quality assurance of data communication is implemented in a communication network including a communication device and a communication path calculation device as a component and a network control device used for the system are disclosed. The communication path calculation device includes a communication path managing unit and a communication path calculating unit. The communication path managing unit manages reserved communication paths with quality assurance constructed based on a quality assurance communication path construction request of a communication system administrator and a use communication path allocated from among the reserved communication paths according to the quality assurance communication path allocation request of a communication network user. The communication path calculating unit gives a priority to the reserved communication path and the use communication path, and reconfigures the communication paths in a priority order. A quality assured in the data communication includes a bandwidth, a delay, a jitter, and reliability, and in reconfiguration of the communication path, a communication path in which a variation range of the quality is within a predetermined variation range is allocated.

In another aspect of the present invention, when a communication path being used is re-examined and reconfigured, a communication path in which a variation range of the quality is within a predetermined variation range is allocated. As the quality, there are a bandwidth, a delay, a jitter, reliability, and the like. According to another aspect of the present invention, it is possible to reduce influence of a quality variation on the user when a communication path being used is re-examined and reconfigured.

Hereinafter, exemplary embodiments of the present invention will be described in detail with reference to the appended drawings. Further, substantially the same parts are denoted by the same reference numerals, and a description thereof will not be duplicated. Tables that have the same configuration but are different in content according to circumstances are labeled with and identified by the same reference numerals with a hyphen and a number.

The present invention is not interpreted to be limited to a description of the following embodiments. It would be easily understand by a person skilled in the art that a specific configuration thereof can be modified within the scope not departing from the spirit or gist of the present invention.

In this specification, expressions of “first,” “second,” “third,” and the like are added to identify components, and not intended to necessarily limit a number or an order.

A publication, a patent, and a patent application cited in this specification function as part of the description of this specification as is.

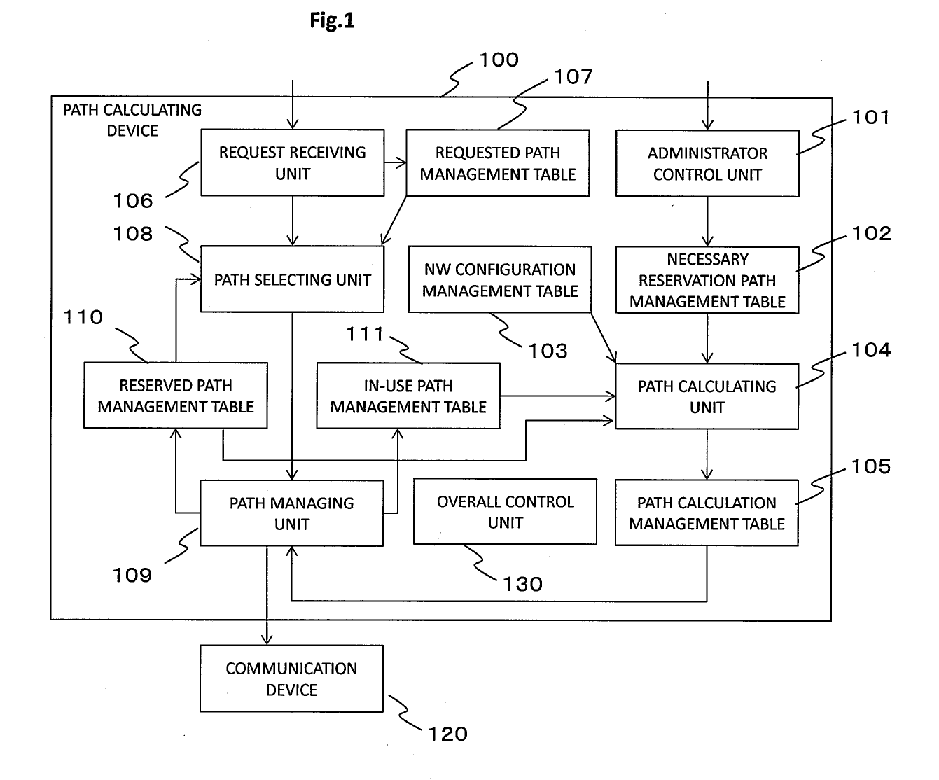

FIG. 1 is a block diagram illustrating a communication system according to the present invention.

The communication system of the present invention includes a path calculating device 100 and a communication device 120.

The path calculating device 100 includes an administrator control unit 101 that receives a control command from a network administrator. The path calculating device 100 further includes a necessary reserved path management table 102 used to manage a necessary reserved path input to the administrator control unit, a network configuration management table 103 used to manage a network configuration of a management target, a path calculating unit 104 that constructs a path, a path calculation management table 105 used to construct a path, a request receiving unit 106 that receives a path request made by a network user, a requested path management table 107 that manages a requested path requested from the user, a path selecting unit 108 that selects a reserved path to be allocated as a requested path, a path managing unit 109 that manages a reserved path and an in-use path, a reserved path management table 110 used to manage a reserved path, and an in-use path management table 111 used to manage an in-use path. An overall control unit 130 controls the device in general.

A specific configuration of the path calculating device may be implemented by a computer including an input device, an output device, a processing device, and a storage device. At this time, the administrator control unit 101 may be configured with, for example, a keyboard serving as the input device. The request receiving unit 106 may be configured with, for example, an input interface serving as the input device. The path selecting unit 108, the path managing unit 109, the path calculating unit 104, and the overall control unit 130 may be implemented by software executed by the processing device such as a CPU. The necessary reserved path management table 102, the network configuration management table 103, the path calculation management table 105, the requested path management table 107, the reserved path management table 110, and the in-use path management table 111 may be stored in a magnetic storage medium or a semiconductor storage device as data.

In the present invention, as will be described later, various kinds of tables mentioned above are periodically updated through the path selecting unit 108, the path managing unit 109, and the path calculating unit 104.

As a typical configuration example of each table, information of a requested path includes information specifying a transmission source, information specifying a transmission destination, and information of a quality to request. Further, information of an in-use path includes information specifying a transmission source, information specifying a transmission destination, information of an assured quality, and information specifying a path configuration. Furthermore, information of a reserved path includes information specifying a transmission source, information specifying a transmission destination, information of an assured quality, and information specifying a path configuration. The information specifying the path configuration is information related to network resources which are allocated to the corresponding path through a re-calculation which will be described later.

The path calculating unit 104 aggregates information of the in-use path management table 111 and the reserved path management table 110, and creates the path calculation management table 105 including information specifying a transmission source, information specifying a transmission destination, information of a quality to be assured, the number of paths to be secured, and information of priority. Further, the path calculating unit 104 performs a calculation for reconfiguring information of the in-use path management table 111 and information of the reserved path management table 110 in a priority order of the path calculation management table 105.

The path managing unit reflects a re-calculation result in the in-use path management table 111, transfers a path validation command for validating the reflected in-use path to the communication device, and enables a path to be used.

The above configuration may be implemented by a single computer, and arbitrary portions of the input device, the output device, the processing device, and the storage device may be configured with other computers connected via a network. They are equivalent in terms of the spirit of the invention.

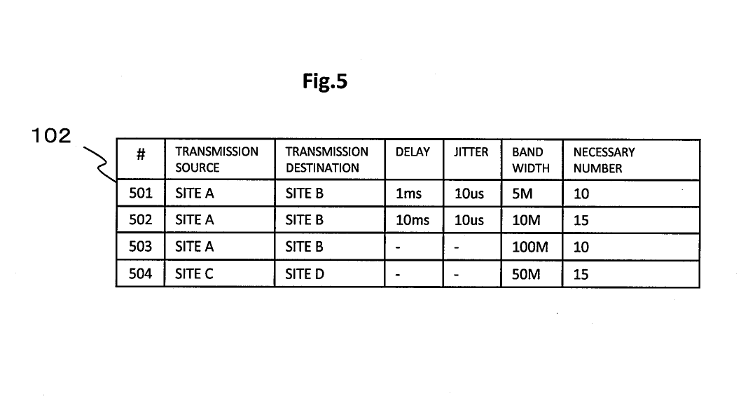

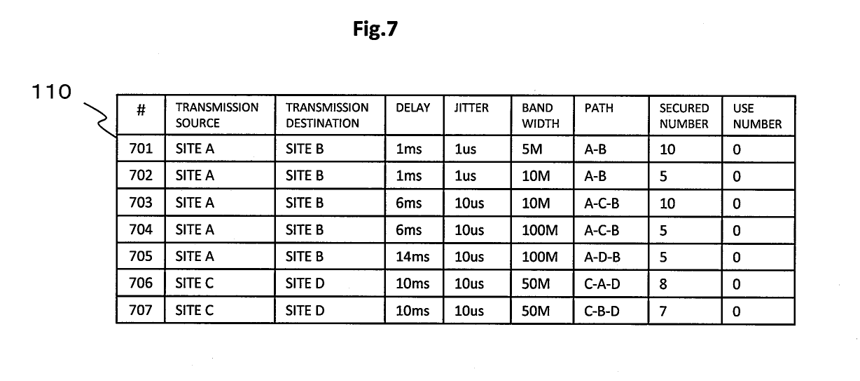

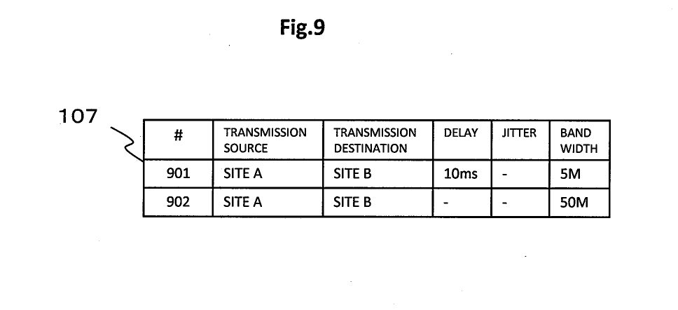

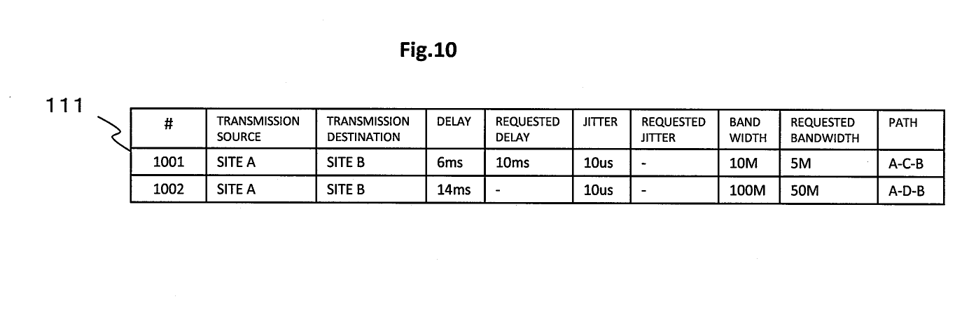

In this specification, “path,” “route,” and “communication path” are used to have the same meaning, and includes at least information of a transmission source and information of a transmission destination. “Path information,” “route information,” and “communication path information” include information of a quality required in a path or the like. For example, necessary reserved path information illustrated in FIG. 5 and requested path information illustrated in FIG. 9 are included. Further, “path information” and “route information” may include network configuration information that is obtained by a route calculation and used to configure an actual path. For example, information of a secured path illustrated in FIG. 7 and use path information illustrated in FIG. 10 are included.

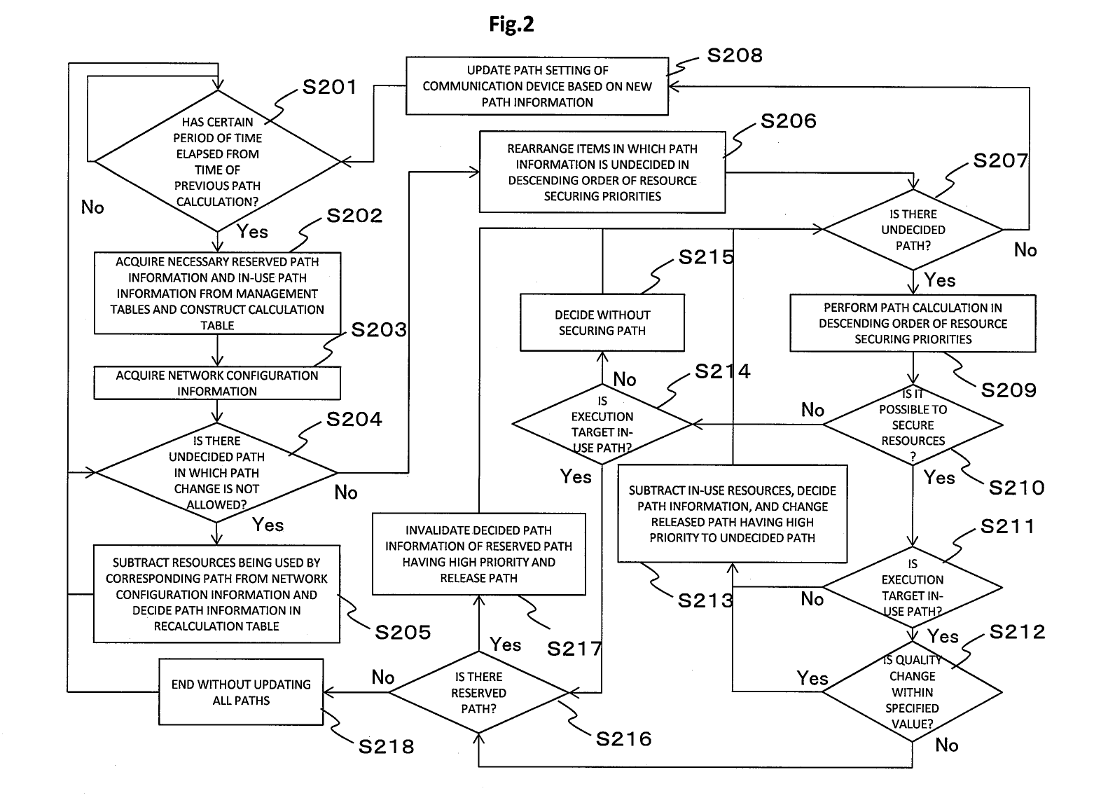

FIG. 2 is a flowchart illustrating a communication path re-examination process in the communication system of the present invention. The flow will be described with reference to the configuration of FIG. 1.

The communication path re-examination process is repeatedly performed at a certain timing through the path calculating device 100.

First, the overall control unit 130 of the path calculating device 100 determines whether or not a certain period of time has elapsed from the time of a previous path calculation (S201). When the certain period of time is determined to have not elapsed, the process returns to a lapse of time determination process (S201).

When the certain period of time is determined to have elapsed in the lapse of time determination process (201), the path calculating unit 104 acquires necessary reserved path information and in-use path information from the necessary reserved path management table 102 and the in-use path management table 111, and constructs the path calculation management table 105 (S202). A method of constructing the path calculation management table 105 will be described later.

The path calculating unit 104 acquires network configuration information from the network configuration management table 103 (S203).

Then, the path calculating unit 104 determines whether or not there is an undecided path in which a route change is not allowed (S204). For example, a path in which a route change is not allowed is a path that is designated through the administrator control unit 101 in advance by an administrator or a path that is determined to be a path satisfying a certain condition through the path calculating unit 104. When it is determined in step 204 that there is an undecided path in which a route change is not allowed, communication resources being used by the corresponding path are subtracted from the network configuration information, the corresponding path information is set as decided information in the path calculation management table 105 (205), and it is determined whether or not there is any other undecided path in which a route change is not allowed (S204). A path in which a route change is not allowed is excluded from a path reconstruction target according to the present invention and thus will not be mentioned in the following description.

When it is determined in step 204 that there is no undecided path in which a route change is not allowed, the path calculating unit 104 rearranges items in which the path information is undecided in the descending order of resource securing priorities, and updates the path calculation management table 105 (S206). A priority decision method will be described later.

Then, the path calculating unit 104 determines whether or not there is a route in which communication resources configuring a path are undecided (S207). When it is determined that there is no route in which communication resources are undecided, since the reserved path management table 110 and the in-use path management table 111 have been completely updated, the path managing unit 109 updates a path setting of the communication device based on new path information (S208), and the process returns to the lapse of time determination process (S201).

When it is determined in step 208 that there is a route in which communication resources are undecided, the path calculating unit 104 performs a repetitive process in which the path calculation and the subsequent process are performed in the descending order of the resource securing priorities (S209 to S217). The repetitive process is repeatedly performed until there is no route in which communication resources are undecided (S207). As an exemplary configuration, the path calculating unit 104 stores copies of the reserved path management table 110 and the in-use path management table 111 in a temporary memory, decides a route of a reserved path or an in-use path in the descending order of priorities, and updates entries of the reserved path management table and the in-use path management table in the temporary memory. When all routes are decided, a completion report is transferred to the path managing unit 109, and the original reserved path management table 110 and the original in-use path management table 111 are updated by the path managing unit 109.

The path calculating unit 104 performs a path calculation and a path decision in the priority order of the path calculation management table 105 (S209). Then, it is determined whether or not it is possible to secure communication resources as a result of the path calculation process (S209) with reference to the network configuration management table 103 (S210).

When it is determined in step 210 that it is possible to secure communication resources, the path calculating unit 104 determines whether or not a path calculation execution target is an in-use path with reference to the in-use path management table 111 (S211). When the path calculation execution target is determined to be an in-use path in step S211, it is determined whether or not a quality change (a deterioration or an improvement) from the current status by communication resources determined to be securable as a result of the path calculation process (S209) falls within a specified value (S212). It is because when the quality of the in-use path significantly varies, the user feels the variation. In other words, when the in-use communication path is re-examined, communication resources being excessively provided in response to the allocation request from the user are sufficiently optimized as necessary, but when communication characteristics significantly vary due to the re-examination, the user recognizes it as a deterioration of the quality. Conversely, even when the quality is extremely improved, it may be commercially undesirable. Here, the quality variation range for the in-use path is limited, but it is desirable to perform the same process even on the reserved path since an extremely significant quality variation affects the quality of the entire service.

As described above, when the in-use communication path is re-examined and reconfigured, an ideal of allocating a communication path in which the quality variation range is within a predetermined variation range is not limited to the configuration of the present embodiment, and may be effectively applied to a technique of re-examining and reconfiguring an in-use communication path.

When the quality change is determined to fall within the specified value in step S212, communication resources determined to be securable by the path calculation process (S209) are regarded as used resources and subtracted from unused resources. A released path that is higher in a priority than the path calculation execution target but is not a path calculation target is changed to an undecided path (S213), and the process returns to the communication resource-undecided route presence/absence determination (S207).

When it is determined in step 210 that it is difficult to secure communication resources, it is determined whether or not the path calculation execution target is an in-use path (S214). When the path calculation execution target is determined to be not an in-use path in step 214, it is decided without securing communication resources of an execution target path (S215), and the process returns to the communication resource-undecided route presence/absence determination (S207).

When the path calculation execution target is determined to be an in-use path in step 214, it is determined whether or not a reserved path is included in a path in which resources are secured in the current status (S216). When the reserved path is determined to be included in step 216, decided path information of the reserved path is invalidated, communication resources secured for the reserved path are released (S217), and the process returns to the communication resource-undecided route presence/absence determination (S207). Since the path calculation and decision are performed in the priority order, a reserved path in which resources are released is a path that is higher in priority than an in-use path.

When the reserved path is determined to be not included in step 216, the path setting re-examination is stopped, the update of all path settings is not performed (S218), and the process returns to the lapse of time determination process (S201). When the reserved path is determined to be not included in step 216, a path in which resources are secured is only an in-use path and higher in a priority than the path calculation execution target since the path calculation and decision are performed in the priority order. Since it is inappropriate to release resources of such an in-use path, the path update is not performed, and the current status is maintained.

When the path calculation execution target is determined to be not an in-use path in step 211, communication resources determined to be securable by the path calculation process (S209) are regarded as used resources and subtracted from unused resources, a released path that is higher in a priority than the path calculation execution target but is not a path calculation target is changed to an undecided path (S213), and the process returns to the communication resource-undecided route presence/absence determination (S207).

When the quality deterioration is determined not to fall within the specified value in step 212, it is determined whether or not a reserved path is included in a path in which resources are secured in a current status (S216). When the reserved path is determined to be included in step 216, the decided path information of the reserved path that is higher in priority than the execution target path is invalidated, communication resources secured for the reserved path are released (S217), and the process returns to the communication resource-undecided route presence/absence determination (S207).

When the reserved path is determined to be not included in step 216, the path setting re-examination is stopped, the update of all path settings is not performed (S218), and the process returns to the lapse of time determination process (S201).

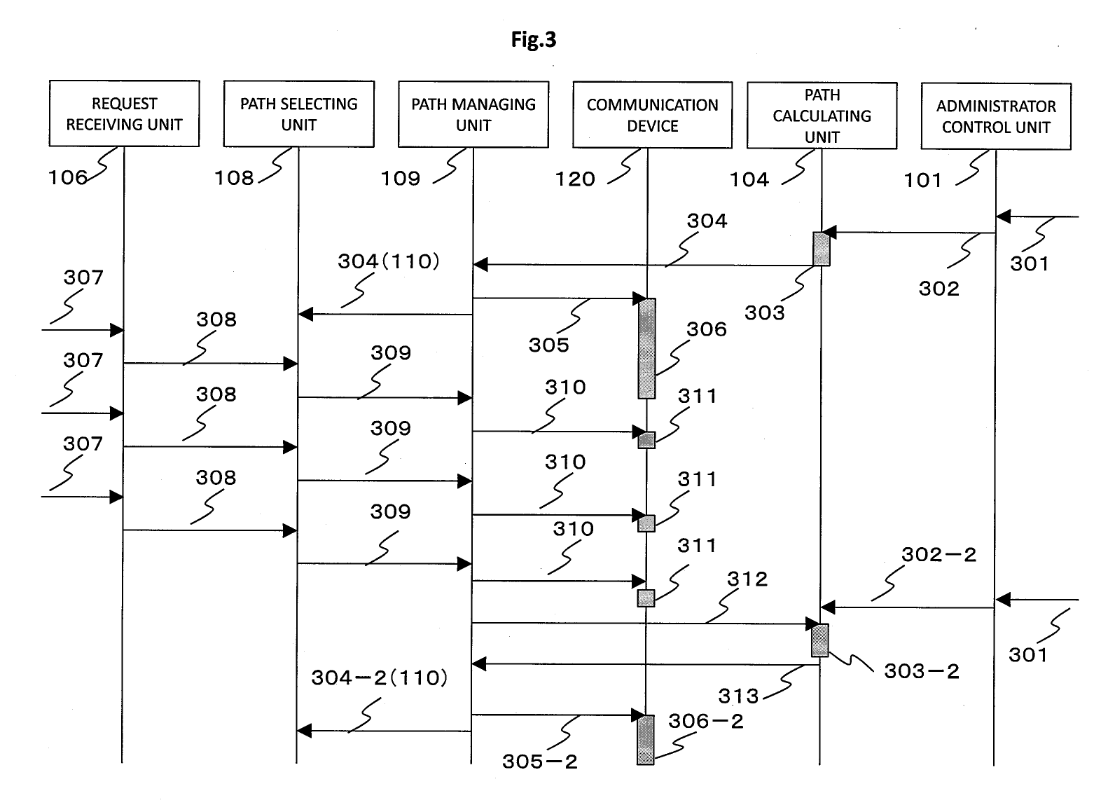

FIG. 3 is a sequence diagram illustrating a communication path creation/re-examination process according to an embodiment, and illustrates the flow of information. A vertical axis is a time axis. For the sake of description, a network is assumed to be an unused state when an administrator setting 301 is performed.

Necessary reserved path information 302 input to the administrator control unit 101 by the administrator setting 301 is stored in the necessary reserved path management table 102. The path calculating unit 104 creates reserved path information 304 through a path calculation 303 described in FIGS. 1 and 2 based on the necessary reserved path information 302 and the like. In the current status, the network is not used, and thus there is no in-use path information. The reserved path information 304 is transferred to the path selecting unit 108 as the reserved path management table 110 via the path managing unit 109. Further, a path setting 305 is transferred from the path managing unit 109 to the communication device 120. Each communication device 120 receives the path setting 305, and performs a path setting process 306.

The path selecting unit 108 is notified of a path request 308 serving as a user request 307 that is made by the user and input to the request receiving unit 106. The path selecting unit 108 selects a reserved path satisfying the request from reserved paths secured in the reserved path management table 110. At this time, it is desirable to select a reserved path having a quality whose variation range from the request is small while satisfying the requested quality from among the reserved paths. Here, a resource waste caused by a measurable over-specification is unavoidable as long as one of the reserved paths is selected. Such a waste can be expected to be improved by performing a path re-examination later through a path calculation 303-2.

The selected reserved path is transferred to the path managing unit 109 as a reserved path use notification 309. Further, a path validation command 310 for validating a set path is transferred from the path managing unit 109 to the communication device 120. Each communication device 120 that has received the path validation command 310 performs a path validation process 311.

The path calculation 303-2 is performed again with a certain period. After an immediately previous path calculation 303, when necessary reserved path information 302-2 is transferred from the administrator control unit 101 to the path calculating unit 104 again or when path use information 312 is transferred from the path managing unit 109 to the path calculating unit 104, the path calculating unit 104 performs the path re-examination through the path calculation 303-2 based on this information, and path information 313 after the re-examination is transferred to the path managing unit 109. The path information 313 after the re-examination includes the reserved path information and the in-use path information, and the path managing unit 109 updates the reserved path management table 110 and the in-use path management table 111 based on the reserved path information and the in-use path information.

Based on the updated path information, the path managing unit 109 transfers a path relocation setting 305-2 to the communication device 120, and transfers new reserved path information 304-2 (110) to the path selecting unit 108. Upon receiving the path relocation setting 305-2, the communication device 120 performs a path re-setting process 306-2.

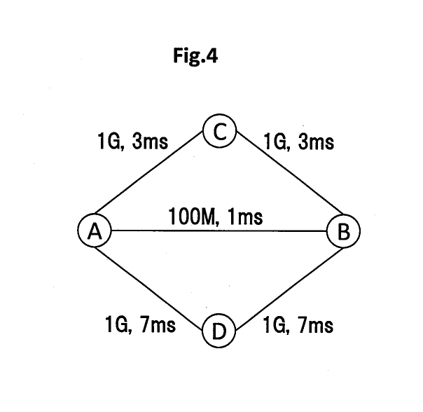

FIG. 4 is a network diagram according to an embodiment of the present invention. For the sake of simple description, in a description of a route calculation and the like, only a delay time and a bandwidth are considered, and a jitter shown in various kinds of tables is not mentioned, but a similar approach is used although the number of types of characteristics to consider is increased.

A network is configured with four communication devices A, B, C, and D. The communication devices A and B are connected to each other via a line having a bandwidth of 100 Mbps and a delay of 1 ms, the communication devices A and C are connected to each other via a line having a bandwidth of 1 Gbps and a delay of 3 ms, the communication devices B and C are connected to each other via a line having a bandwidth of 1 Gbps and a delay of 3 ms, the communication devices A and D are connected to each other via a line having a bandwidth of 1 Gbps and a delay of 7 ms, and the communication devices B and D are connected to each other via a line having a bandwidth of 1 Gbps and a delay of 7 ms.

FIG. 5 illustrates a specific example of the necessary reserved path management table 102 according to an embodiment of the present invention. The necessary reserved path management table holds the necessary reserved path information input by the administrator. At the time of the input, the administrator creates the necessary reserved path information in view of the network configuration or the previous status of use of the user. The necessary reserved path management table 102 includes a start point (a transmission source) and an end point (a transmission destination) of a necessary reserved path, communication characteristics (which are a delay, a jitter, and a bandwidth in this example, but some characteristics may be omitted, and other characteristics such as reliability, an error rate, and a price may be added), and the number of necessary paths (a necessary number), and has an entry for each of paths that differ in the start point, the end point, and the communication characteristics. A path whose communication characteristics are indicated by “-” is a path which does not particularly require a quality. In the example of FIG. 5, for the sake of easy description, a 3-digit number is employed as an entry number, but the entry number is not limited to this example. Even in other tables described below, a 3- or 4-digit entry number is used due to the same reason.

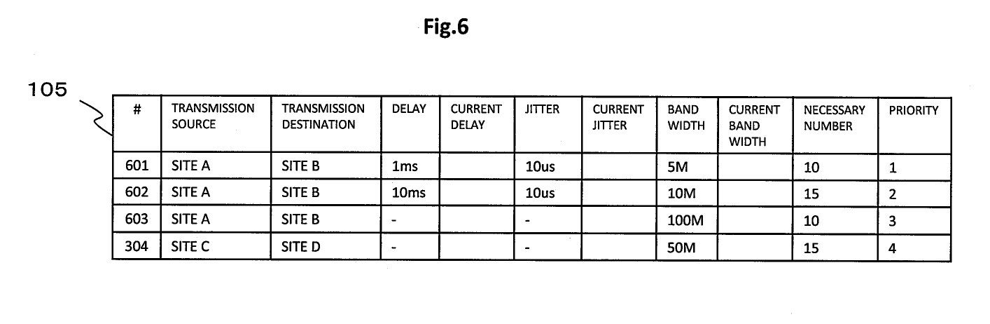

FIG. 6 is a specific example of the path calculation management table 105 according to an embodiment of the present invention. The path calculation management table 105 holds information in which the information of the necessary reserved path management table 102 (FIG. 5) and the information of the in-use path management table 111 (FIG. 10) which will be described later are aggregated, and a priority used when a route calculation of a path is performed is given.

The path calculating unit 104 which will be described later allocates network resources in the priority order of the path calculation management table 105. The priority may be decided based on an arbitrary rule. In the path calculation management table 105, a path secured for use and an in-use path are aggregated, and arranged based on the same criterion (priority). For example, the priority is defined as a degree of difficulty in securing communication resources necessary for a required quality assurance. In this case, the descending order of necessary quality levels is used. As a specific example, a required quality level can be obtained by normalizing a value of each quality based on a network average value of qualities such a delay time, a jitter, and a bandwidth and performing a certain calculation. As an example, the product of a reciprocal of a normalized delay time, a reciprocal of a normalized jitter, and a normalized bandwidth is obtained, and a priority ranking is allocated in the descending order of the products. Further, any other calculation formula may be used instead of a simple product. In this case, it is possible to evaluate various qualities collectively using the same index, and thus network resources can be expected to be effectively used.

A weighting may be applied to each quality. For example, when a weighting of a bandwidth is set to zero, a required quality level can be calculated based on a delay and a jitter while ignoring a bandwidth. Further, a method of deciding a ranking based on a certain quality (for example, a delay) and deciding a ranking based on a jitter when the delays are equal may be used.

Alternatively, a value of data may be simply used without normalization. In this case, for example, compared to when a delay is 10 ms, when a delay is 1 ms, it is more difficult to secure resources, and a priority is higher.

The path calculation management table 105 includes a start point (a transmission source) and an end point (a transmission destination) of a necessary reserved path, necessary communication characteristics (a delay, a jitter, and a bandwidth in this example), current communication characteristics (a current delay, a current jitter, and a current bandwidth in this example), the number of necessary paths (a necessary number), and a priority used when a route calculation of a path is performed, and has an entry for each of paths that differ in the start point, the end point, the communication characteristics, and the priority. A path whose communication characteristics are indicated by “-” is a path which does not particularly require a quality (the same applies hereinafter).

Now, for the sake of description, a state of FIG. 6 is assumed to an initial state of a network system, that is, a state in which the user does not use a network. Thus, since the in-use path management table 111 is in a blank state, only the state of the necessary reserved path management table 102 (FIG. 5) is aggregated. Entries #501, #502, #503, and #504 of the necessary reserved path management table 102 correspond to entries #601, #602, #603, and #604 of the path calculation management table 105 respectively, and a priority is given. Since there is no path being used, quality columns of the current status are blank.

FIG. 7 illustrates a specific example of the reserved path management table 110 according to an embodiment of the present invention. The reserved path management table 110 holds information of paths secured by performing a route calculation of a path based on the path calculation management table 105 (FIG. 6) through the path calculating unit 104. In the route calculation, paths satisfying required qualities illustrated in FIG. 6 are created, for example, using available resources of the network illustrated in FIG. 4. The route calculation of a path is a well-known technique. the reserved path management table 110 includes a start point (a transmission source) and an end point (a transmission destination) of a necessary reserved path, necessary communication characteristics (a delay, a jitter, and a bandwidth in this example), a route of a secured path (a route), the number of secured paths (a secured number), the number of paths being used (a use number), and has an entry for each of paths that differ in the start point, the end point, communication characteristics, and the route.

The paths of the reserved path management table 110 are selected according to the requested path management table (FIG. 9) indicating the user's requested path which will be described later and supplied for use by the user.

The example of FIG. 7 illustrates reserved path information that is allocated based on the path calculation management table 105 of FIG. 6 by the path calculating unit 104 on the premise of the network configuration of FIG. 4. A path of the entry 601 of the path calculation management table 105 is allocated to a path of an entry 701 of the reserved path management table 110. A path of the entry 602 is allocated to paths of entries 702 and 703. A path of the entry 603 is allocated to paths of entries 704 and 705. A path of the entry 604 is allocated to paths of entries 706 and 707.

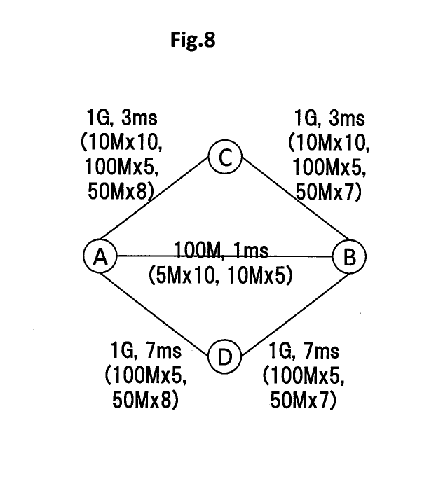

FIG. 8 is a network diagram after a reserved path is secured according to an embodiment of the present invention. A number in parentheses indicates resources of a path reserved by the reserved path management table 110 of FIG. 7. The paths of the entries 701 and 702 of the reserved path management table 110 of FIG. 7 are allocated to the line between the communication devices A and B, the paths of 703, 704, and 706 are allocated to the line between the communication devices A and C, the paths of 703, 704, and 707 are allocated to the line between the communication devices B and C, the paths of 705 and 706 are allocated to the line between the communication devices A and D, and the paths of 705 and 707 are allocated to the line between the communication devices B and D.

Through the above process, the reserved path management table 110 is created, and a preparation for receiving a use request from the network user is completed.

FIG. 9 illustrates a specific example of the requested path management table 107 according to an embodiment of the present invention, and the requested path management table 107 holds path information requested from the network user. The requested path management table 107 includes a start point (a transmission source) and an end point (a transmission destination) of a necessary reserved path, and communication characteristics (a delay, a jitter, and a bandwidth in this example), and has an entry for each path.

The path selecting unit 108 selects a requested path of the user indicated by the requested path management table 107 with reference to the reserved path management table 110. At this time, a path satisfying a quality characteristic requested by the user is selected based on the reserved path management table 110. Preferably, a path having a closest quality characteristic while satisfying a quality characteristic requested by the user is selected.

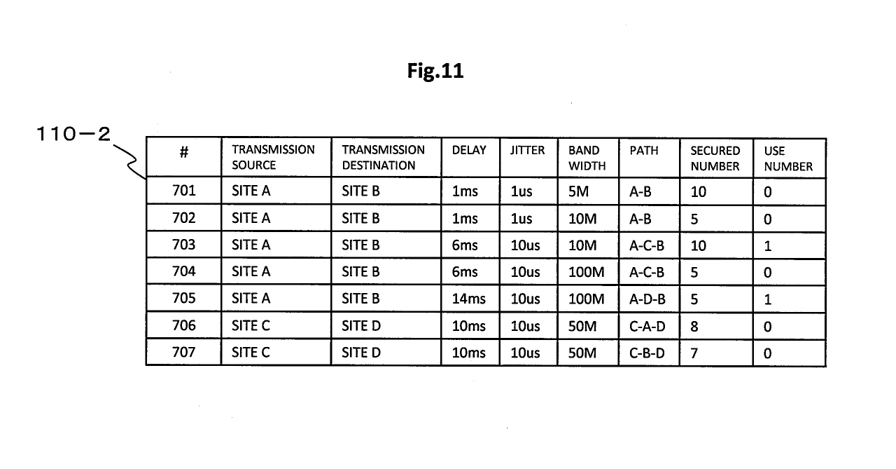

When the path of the reserved path management table 110 is allocated to the user, the path selecting unit 108 notifies the path managing unit 109 of the allocated path. The path managing unit 109 reflects the allocated path in the reserved path management table 110, and subtracts the secured number of the corresponding path (which will be described with reference to FIG. 11). Further, the path managing unit 109 registers the allocated path in the in-use path management table 111 (which will be described with reference to FIG. 10).

FIG. 10 illustrates a specific example of the in-use path management table 111 according to an embodiment of the present invention. The in-use path management table 111 holds path information allocated from the reserved path management table 110 of FIG. 7 according to the requested path management table 107 of FIG. 9. The requested path management table 107 includes a start point (a transmission source) and an end point (a transmission destination) of a path, communication characteristics (a delay, a jitter, and a bandwidth in this example), originally requested communication characteristics (a requested delay, a requested jitter, and a requested bandwidth in this example), and a route of an allocated path (a route), and has an entry for each path.

The in-use path management table 111 illustrated in FIG. 10 is one in which a path suitable for a requested path indicated by the requested path management table illustrated in FIG. 9 is selected from the reserved path management table illustrated in FIG. 7 and allocated. The path of the entry 703 of FIG. 7 is selected as a path satisfying qualities of the entry 901 of FIG. 9, and registered as an entry 1001 of the in-use path management table of FIG. 10. Further, the path of the entry 705 of FIG. 7 is selected as a path satisfying qualities of the entry 902 of FIG. 9, and registered as an entry 1002 of the in-use path management table of FIG. 10.

FIG. 11 illustrates a specific example of a reserved path management table 110-2 after a requested path is allocated according to an embodiment of the present invention. The paths of the entries 703 and 705 are allocated to the requested paths of the requested path management table 107 of FIG. 9, and the use number thereof is increased by one.

A mutual relation among the necessary reserved path management table 102, the path calculation management table 105, the requested path management table 107, the reserved path management table 110, and the in-use path management table 111 has been described above.

In the present embodiment, the path calculation management table 105 is periodically reconstructed. At the time of reconstruction, the information of the necessary reserved path management table 102 of FIG. 5 and the information of the in-use path management table 111 of FIG. 10 are aggregated, a priority ranking is given again, and a path is allocated according to a priority ranking.

There are several reconstruction methods, and each of the reconstruction methods will be described below in detail.

### First Embodiment

A first embodiment in which a path allocation re-calculation is performed in the order of the in-use path and reserved path will be described.

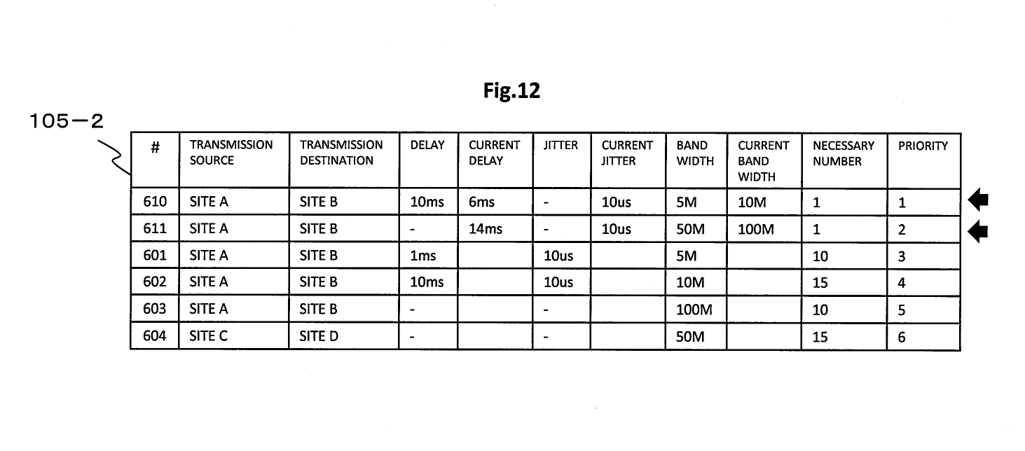

FIG. 12 illustrates a specific example of a path calculation management table 105-2 according to the first embodiment. The path calculation management table 105-2 holds information obtained by aggregating the information of the necessary reserved path management table 102 of FIG. 5 and the information of the in-use path management table 111 of FIG. 10 and giving a priority used when a route calculation of a path is performed such that an in-use path is given a priority higher than a reserved path.

Since there is not in-use path in the state of the path calculation management table 105 of FIG. 6, the path calculation management table is a table in which no in-use path is reflected. A difference with the path calculation management table 105 of FIG. 6 lies in that in the path calculation management table 105-2 of FIG. 12, in-use paths of entries 610 and 611 indicated by arrows are aggregated in conjunction with the reserved path. A path of the entry 610 is the path of the entry 1001 of the in-use path management table 111 of FIG. 10, and the path of the entry 611 is the path of the entry 1002.

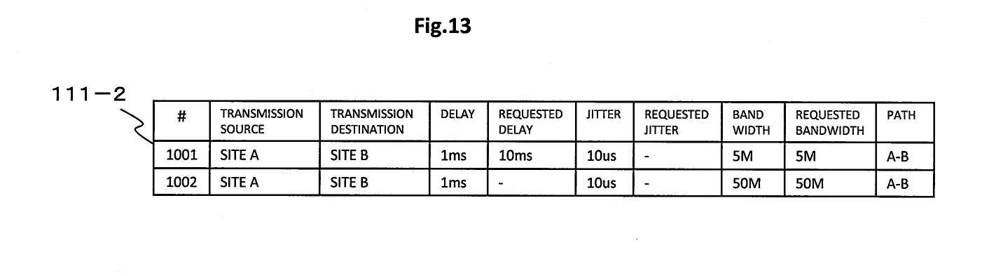

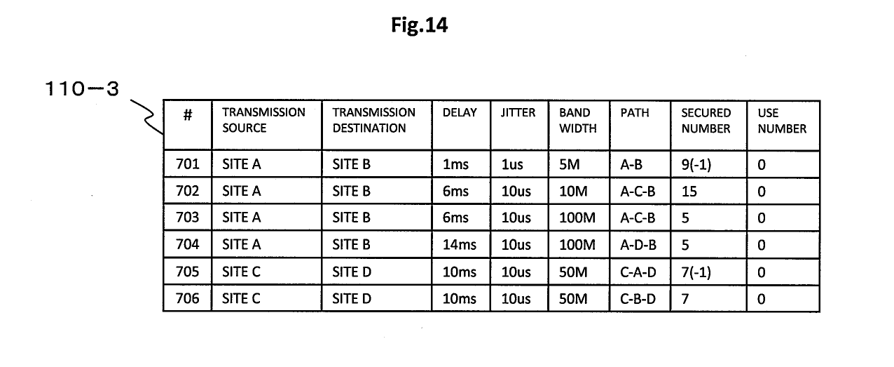

In the reconstruction method of the present embodiment, the priority of the in-use path is consistently set to be high. Thus, for the in-use paths of the entries 610 and 610 having a high priority in the path calculation management table 105-2, the path calculation by the path managing unit 109 is first performed, and a path is preferentially allocated. The allocated path is registered in the in-use path management table 111 (which will be described with reference to FIG. 13). If the necessary reserved path management table 102 is assumed to have the same content as that illustrated in FIG. 5, content of the entries 601 to 604 are the same as those illustrated in FIG. 6. Thus, for the entries 601 to 604 of the reserved paths that are not being used, a path is allocated thereafter. The allocated path is registered in the reserved path management table 110 (which will be described with reference to FIG. 14). A priority calculated based on a quality characteristic may be applied to between in-use paths or between reserved paths (the same applies in the following embodiments).

In the method according to the present embodiment, an in-use path is preferentially subject to a path re-allocation consistently at the time of reconstruction, and thus communication being used is unlikely to be affected.

FIG. 13 illustrates a specific example of an in-use path management table 111-2 obtained by performing a route calculation of a path again based on the path calculation management table 105-2 of FIG. 12 when the re-examination is performed in the order of the in-use path and the reserved path. The paths of the entries 610 and 611 of the path calculation management table 105-2 of FIG. 12 are reconfigured. Before the re-examination, a route of a path of a first line is A-C-B, but a route of a path of a second line is A-D-B, but after the re-examination, the routes of the paths of the first and second lines are changed to A-B.

In the present embodiment, since even the configuration of the in-use path is periodically re-examined, it is possible to prevent resources more than necessary from being continuously occupied by the in-use path.

FIG. 14 illustrates a specific example of a reserved path management table 110-3 obtained by performing a route calculation of a path again based on the path calculation management table 105-2 of FIG. 12. The number of secured reserved paths of an entry 701 is smaller than the number of necessary paths required in the necessary reserved path management table 102 illustrated in FIG. 5 by one. It is a path allocation on the entry 601 of the path calculation management table 105-2 of FIG. 12. Further, the number of secured reserved paths of an entry 705 is smaller by one. It is a path allocation on the entry 604 of the path calculation management table 105-2 of FIG. 12. In the present embodiment, since the in-use path is preferentially subjected to the path allocation, there are cases in which it is difficult to secure a path even for a reserved path having a high priority due to the influence of the in-use path.

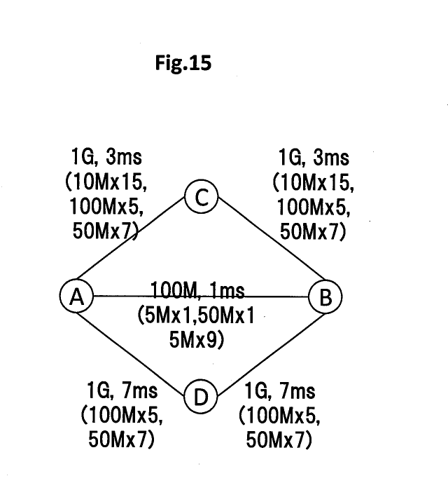

FIG. 15 is a network diagram after a re-calculation is performed based on the path calculation management table 105-2 of FIG. 12. The paths of the entries 1001 and 1002 of FIG. 13 and the entry 701 of FIG. 14 are allocated to the line between the communication devices A and B, the paths of the entries 702, 703, and 705 of FIG. 14 are allocated to the line between the communication devices A and C, the paths of the entries 702, 703, and 706 of FIG. 14 are allocated to the line between the communication devices B and C, the paths of the entries 704 and 705 of FIG. 14 are allocated to the line between the communication devices A and D, and the paths of the entries 704 and 706 of FIG. 14 are allocated to the line between the communication devices B and D.

### Second Embodiment

When the reserved communication path is re-examined after the in-use communication path is re-examined as in the first embodiment, communication resources having excellent communication characteristics are secured in order from the in-use communication path. Thus, the quality of the communication path being used is preferentially secured, but it may be difficult to secure communication resources of the reserved communication path.

Further, as a result of preferentially allocating communication resources to be secured to the in-use communication path, communication resources that are most desirable in construction of a communication path required later may be expended, and it may be difficult to assure optimization of the entire network system.

In this regard, a second embodiment in which a path allocation re-calculation is performed in the order of the reserved path and the in-use path will be described.

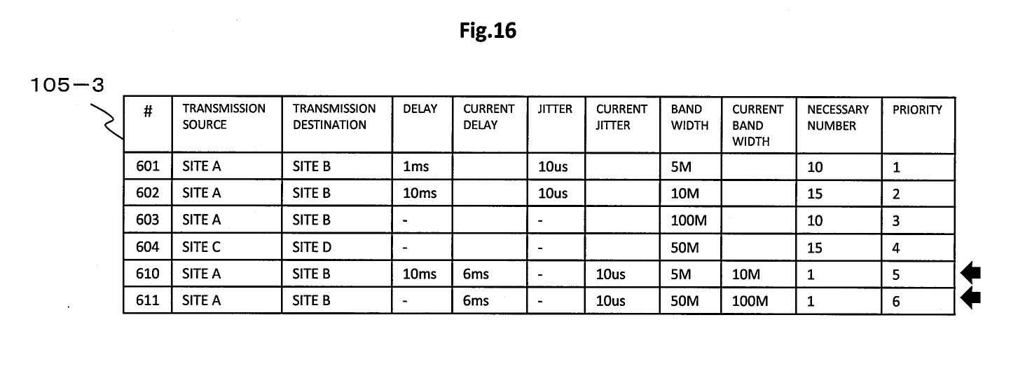

FIG. 16 illustrates a specific example of a path calculation management table 105-3 according to the second embodiment. The information of the necessary reserved path management table 102 of FIG. 5 and the information of the in-use path management table 111 of FIG. 10 are aggregated in path calculation management table 105-3. Further, the path calculation management table 105-3 holds information obtained by giving a priority used when a route calculation of a path is performed such that a reserved path is given a priority higher than an in-use path.

It can be understood that the reconfiguration priority orders of the in-use paths (entries 610 and 611) indicated by arrows are lowered, compared to the path calculation management table 105-2 (FIG. 12) of the first embodiment.

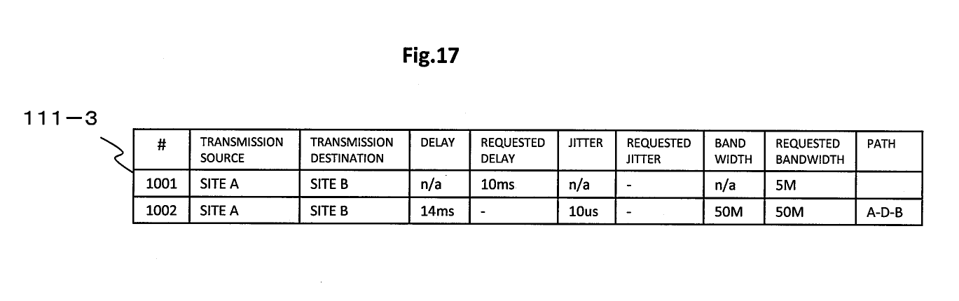

FIG. 17 is a specific example of an in-use path management table 111-3 obtained by performing a route calculation of a path again based on the path calculation management table 105-3 of FIG. 16. As indicated by “n/a,” an entry 1001 of the in-use path has not been secured. It is the in-use path of the entry 610 of the path calculation management table 105-3 of FIG. 16. Since the reserved path is preferentially allocated, the in-use path has not been secured due to the influence of the reserved path.

In this case, in order to prevent a phenomenon that the in-use path cannot be used by the user, it is necessary to invalidate the decided path information of the reserved path having a high priority, open a path, and perform a re-allocation. This process has been described above in the reserved path open step S217 of FIG. 2.

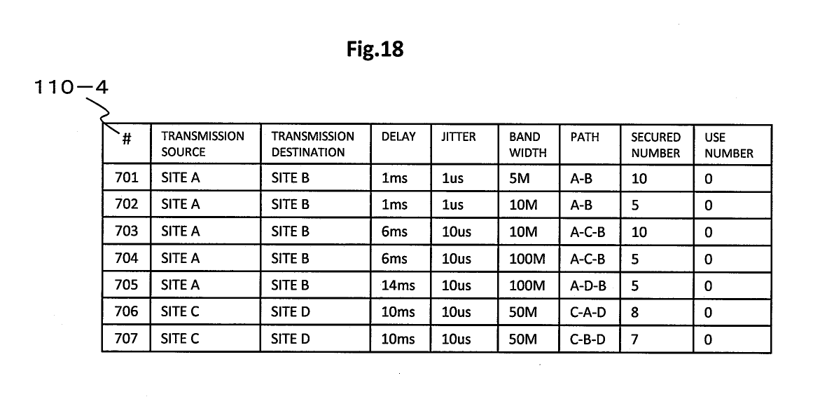

FIG. 18 illustrates a specific example of a reserved path management table 110-4 obtained by performing a route calculation of a path again based on the path calculation management table 105-3 of FIG. 16. The path is secured, similarly to the reserved path management table 110 of FIG. 7.

In the present embodiment, since a path allocation of a reserved path is preferentially performed, it is possible to preferentially satisfy the request of the necessary reserved path management table 102. Thus, it is possible to perform a network setting according to the administrator's intention. However, as described above, it is necessary to perform a re-allocation of an in-use path that is not subjected to a path allocation depending on circumstances.

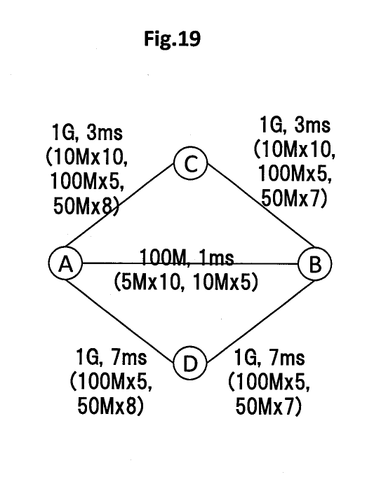

FIG. 19 is a network diagram after a re-calculation is performed based on the path calculation management table 105-3 of FIG. 16. The paths of the entries 701 and 702 of FIG. 18 are allocated to the line between the communication devices A and B, the paths of the entries 702, 704, and 706 of FIG. 18 are allocated to the line between the communication devices A and C, the paths of the entries 703, 704, and 707 of FIG. 18 are allocated to the line between the communication devices B and C, the paths of the entry 1002 of FIG. 17 and the entries 705 and 706 of FIG. 18 are allocated to the line between the communication devices A and D, and the paths of the entry 1002 of FIG. 17 and the entries 705 and 707 of FIG. 18 are allocated to the line between the communication devices B and D.

### Third Embodiment

When the in-use communication path is re-examined after the reserved communication path is re-examined as in the second embodiment, communication resources having excellent communication characteristics are secured for the reserved communication path. Thus, the request of the network administrator or the user is preferentially satisfied. On the other hand, it may be difficult to newly secure an in-use communication path being provided. Or, in order to secure an in-use communication path, it is necessary to re-allocate a path. A third embodiment will be described in connection with an example in which a communication path is re-examined in view of both an in-use communication path and a reserved communication path.

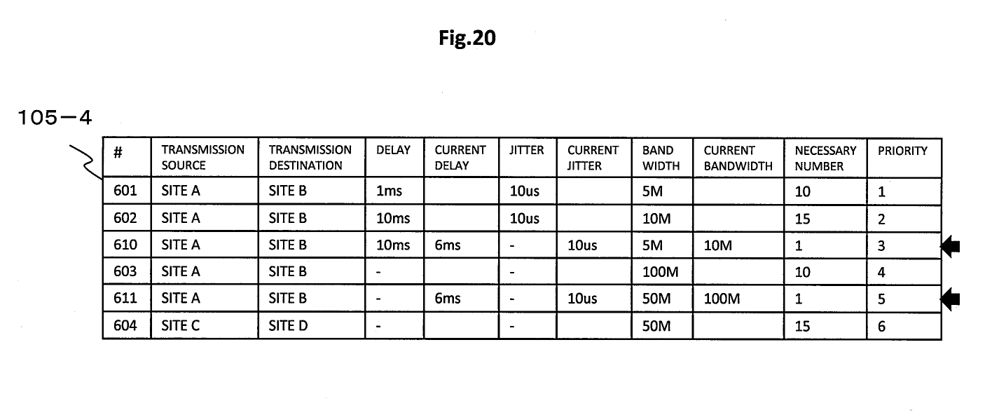

FIG. 20 illustrates a specific example of a path calculation management table 105-4 when the re-examination is performed according to the present embodiment, and the information of the necessary reserved path management table 102 of FIG. 5 and the information of the in-use path management table 111 of FIG. 10 are aggregated in the path calculation management table 105-4. In FIG. 5, unlike FIGS. 12 and 16, the path calculation management table 105-4 holds information obtained by giving a priority used when a route calculation of a path is performed in a resource securing priority order without distinction between a reserved path and an in-use path.

In other words, in the path calculation management table 105-4, entries 601, 602, 603, and 604 serving as a reserved path are allocated priority orders 1, 2, 4, and 6, respectively. In-use paths path (entries 610 and 611) indicated by arrows are allocated priority orders 3 and 5, respectively.

The path managing unit 109 performs a path calculation according to the priority order of the path calculation management table 105-4. The calculated paths are copies of the in-use path management table 111 and the reserved path management table 110 held in the path calculating unit 104 and temporarily registered.

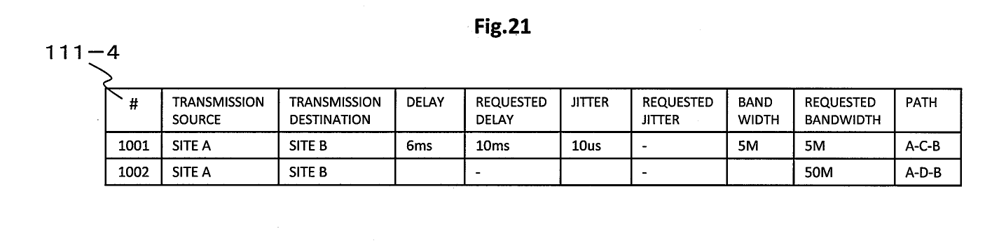

FIG. 21 illustrates a specific example of an in-use path management table 111-4 obtained by performing a route calculation of a path again based on the path calculation management table 105-4 of FIG. 20 when the re-examination is performed according to the present embodiment. Unlike FIG. 17 in which the priority order of the in-use path is low, both of two paths have been secured as the in-use path. In the present embodiment, since the priority order is given to the in-use path and the reserved path based on the same criterion, it is possible to satisfy the requests of both paths in a balanced manner.

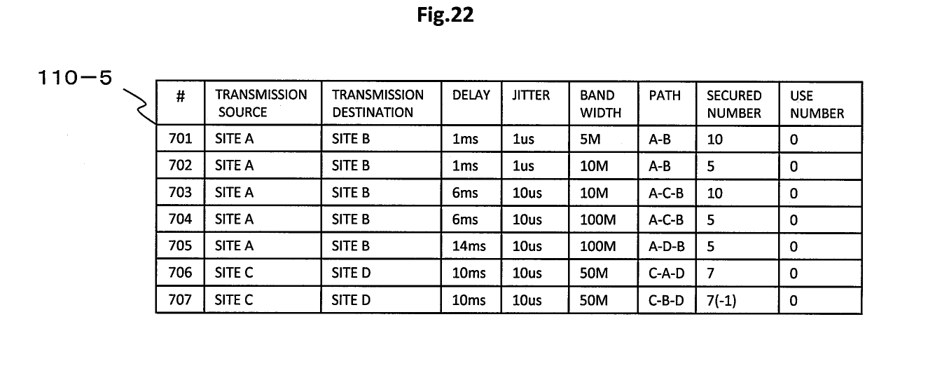

FIG. 22 illustrates a specific example of a reserved path management table 110-5 obtained by performing a route calculation of a path again based on the path calculation management table 105-4 of FIG. 20 when the re-examination is performed according to the embodiment of the present invention. No path has been secured for an entry 707 of the reserved path (the path of the entry 604 of the path calculation management table 105-4 of FIG. 20), and among the reserved paths, only a path having the lowest priority (a priority 6) has not been secured.

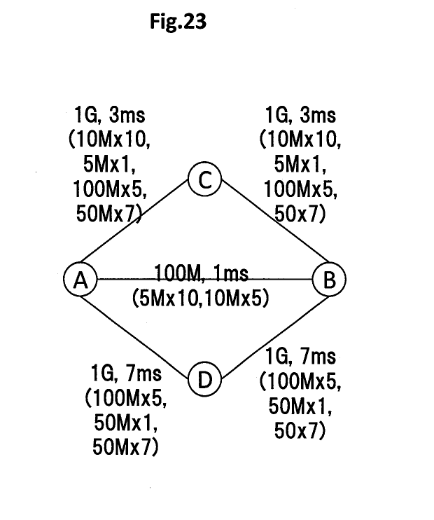

FIG. 23 is a network diagram after the re-examination is performed according to the embodiment of the present invention. The paths of the entries 701 and 702 are allocated to the line between the communication devices A and B, the paths of the entry 1001 of FIG. 21 and the entries 702, 704, and 706 of FIG. 22 are allocated to the line between the communication devices A and C, the paths of the entry 1001 of FIG. 21 and the entries 703, 704, and 707 of FIG. 22 are allocated to the line between the communication devices B and C, the paths of the entry 1002 of FIG. 21 and the entries 705 and 706 of FIG. 22 are allocated to the line between the communication devices A and D, and the paths of the entry 1002 of FIG. 21 and the entries 705 and 707 of FIG. 22 are allocated to the line between the communication devices B and D.

As described above, in the present embodiment, the user gives the priority order to the in-use path and the reserved path based on the same criterion, and the path re-calculation is performed according to the priority order. Thus, it is a method of easily satisfying the requests of both the in-use path and the reserved path while reducing a waste of an allocation of resources.

### Fourth Embodiment

In the first to third embodiments, the three policies in which a route calculation of a path is performed based on the path calculation management table have been described. The policies can be switched according to a status of use of a network or an application target.

For example, in FIG. 1, a configuration in which the network administrator can input a command for switching a method (policy) of constructing the path calculation management table from the administrator control unit 101 to the path calculating unit 104 may be provided. The switching may be performed according to an input of the command or may be performed according to a schedule designated by the command.

Further, a network system may be divided into a plurality of blocks, and different policies may be applied to the blocks. In this case, a plurality of sets each of which includes the requested path management table, the in-use path management table, the reserved path management table, and the network configuration management table are provided. For example, when a communication network is divided into three blocks, and the methods of the first to third embodiments are applied to the three blocks, each table of FIG. 1 is created for each policy, and three tables are provided (not illustrated).

Further, it may be possible to designate a re-calculation condition when an in-use path or a reserved path is re-calculated. For example, the re-calculation condition refers to “a route of A-B-C is not used,” “there are three or more types as a configuration of a path from a site A to a site B,” and the like when the route calculation of the reserved path of FIG. 7 is performed. Further, the re-calculation condition refers to a designation of the number of paths to be secured and the like. The network administrator may input this condition through the administrator control unit 101 and notify the path calculating unit 104 of the condition.

To this end, as a configuration, an output unit (for example, an image monitor) performs a standby display for receiving a condition or a method (policy) of re-calculating information of a reserved path, and an input unit (for example, a keyboard) receives an input according to the standby display, and transfers the input information to the path calculating unit. The path calculating unit performs a calculation based on the condition.

The above embodiments are exemplary embodiments of the present invention, and may be modified within the scope not departing from the gist of the present invention.

The present invention is not limited to the above embodiments, and includes various modified examples. For example, some components of a certain embodiment may be replaced with components of another embodiment, and components of another embodiment may be added to components of a certain embodiments. Further, an addition, a deletion, and a replacement of components of other embodiments may be performed on some components of each embodiment.

In the present embodiment, a function equivalent to a function implemented by software can be implemented even by hardware such as Field Programmable Gate Array (FPGA) or Application Specific Integrated Circuit (ASIC). This aspect is included in the scope of the present invention as well.

1. A communication system in which a communication path with quality assurance of data communication is implemented in a communication network including a communication device and a communication path calculation device as a component,
wherein the communication path calculation device includes an input unit, an output unit, a storage unit, a communication path managing unit, and a communication path calculating unit,
the communication path managing unit manages reserved communication paths with quality assurance constructed based on a quality assurance communication path construction request of a communication system administrator input to the input unit and a use communication path allocated from among the reserved communication paths according to the quality assurance communication path allocation request of the communication network user input to the input unit, and
the communication path calculating unit gives a priority to the reserved communication path and the use communication path, and reconfigures the reserved communication path and the use communication path in a priority order.

2. The communication system according to claim 1,
wherein a quality assured in the data communication includes at least one of a bandwidth, a delay, a jitter, and reliability, and
in reconfiguration of the communication path, a communication path in which a variation range of the quality is within a predetermined variation range is allocated.

3. The communication system according to claim 1,
wherein in a process of allocating the use communication path from among the reserved communication paths according to the quality assurance communication path allocation request of the communication network user,
a reserved communication path of a quality in which a variation range from the quality assurance communication path allocation request is small is selected among the reserved communication paths, and allocated as the use communication path.

4. The communication system according to claim 1,
wherein in a process of reconfiguring the use communication path,
a setting not to reconfigure the use communication path is possible.

5. The communication system according to claim 1,
wherein when it is determined that it is difficult to reconfigure the use communication path, communication resources of the reserved communication path having a higher priority than the use communication path are released, and communication resources of the use communication path are secured.

6. A network control device, comprising:
an input unit;
an output unit;
a storage unit; and
a processing unit, wherein
the network control device is connected with a communication device configuring a network via the input unit and the output unit, and controls a setting of a communication path used by a user by controlling a setting of the communication device,
the storage unit includes
a requested path management table that stores information of a requested path serving as a communication path requested by the user,
an in-use path management table that stores information of an in-use path serving as a communication path being used by the user,
a reserved path management table that stores information of a reserved path serving as a communication path that is secured in advance for use by the user, and
a network configuration management table that stores information related to a configuration of the network, and
the processing unit includes
a path selecting unit that selects a path for use by the user from the reserved path management table based on the information of the requested path,
a path calculating unit that aggregates information of the in-use path management table and information of the reserved path management table at a periodic or arbitrary timing, gives a priority to the in-use path and the reserved path, and re-calculates information of the in-use path and information of the reserved path in an order of the priority based on information of the network configuration management table, and
a path managing unit that reflects a result of the re-calculating in the in-use path management table and the reserved path management table.

7. The network control device according to claim 6,
wherein the information of the requested path includes at least information specifying a transmission source, information specifying a transmission destination, and information of a requested quality,
the information of the in-use path includes at least information specifying a transmission source, information specifying a transmission destination, information of an assured quality, and information specifying a configuration of a path,
the information of the reserved path includes at least information specifying a transmission source, information specifying a transmission destination, information of an assured quality, and information specifying a configuration of a path,
the path calculating unit aggregates the information of the in-use path management table and the information of the reserved path management table, and creates a path calculation management table including information specifying a transmission source, information specifying a transmission destination, information of a quality to be assured, the number of paths to be secured, and priority information, and
the path calculating unit performs a calculation for reconfiguring the information of the in-use path management table and the information of the reserved path management table in an order of a priority of the path calculation management table.

8. The network control device according to claim 7,
wherein the priority of the path calculation management table is decided based on the information of the quality without distinction between the reserved path and the in-use path.

9. The network control device according to claim 7,
wherein the priority of the path calculation management table is decided such that one of the reserved path and the in-use path is higher in priority than the other.

10. The network control device according to claim 7,
wherein the information of the quality includes at least one of a bandwidth, a delay, a jitter, and reliability, and
when the information of the in-use path management table or the reserved path management table is reconfigured, a limit in which a variation of the quality is within a predetermined variation range is set, and a calculation is performed.

11. The network control device according to claim 7,
wherein the information of the quality includes at least one of a bandwidth, a delay, a jitter, and reliability, and
when the information of the in-use path management table or the reserved path management table is reconfigured, a setting not to perform the reconfiguration under a certain condition is possible.

12. The network control device according to claim 7,
wherein when the information of the in-use path management table or the reserved path management table is reconfigured, if it is difficult to secure communication resources for the in-use path, communication resources of the reserved path having a higher priority than the in-use path are released, and communication resources of the in-use path are secured.

13. The network control device according to claim 7,
wherein the path managing unit reflects a result of the re-calculating in the in-use path management table, and transfers a path validation command for validating a reflected in-use path to a communication device.

14. The network control device according to claim 7,
wherein the output unit performs a standby display for receiving a re-calculation condition or method of the information of the reserved path, and
the input unit receives an input according to the standby display, and transfers input information to the path calculating unit.

15. The network control device according to claim 7,
wherein a plurality of sets each of which includes the requested path management table, the in-use path management table, the reserved path management table, and the network configuration management table are provided.
